(19) United States
(12) Patent Application Publication
(10) Pub. No.: US 2003/0039603 A1
(43) Pub. Date: Feb. 27, 2003

(54) Boron doped blue diamond and its production

(76) Inventor: Yue Meng, Naperville, IL (US)

Correspondence Address: Mueller and Smith, LPA, 7700 Rivers Edge Drive, Columbus, OH, 43235, US

(21) Appl. No.: 09/935,957

(22) Filed: Aug. 23, 2001

(51) Int. Cl. B01J 3/06

(52) U.S. Cl. 423/446

(57) ABSTRACT

A method for synthesizing boron doped diamond for improving the oxidation resistance of said diamond crystals includes forming a fully dense core (mixture) of graphite, catalyst/solvent metals, optional diamond seed crystals, and a source of boron. This mixture is subjected to diamond-formed high pressure/high temperature (HP/HT) conditions for a time adequate for forming diamond. The thus-formed diamond product is recovered to contain boron substituted into the diamond structure. The fully dense core is substantially devoid of nitrogen (N) content, which mostly comes from air. Thus, the fully dense core is substantially devoid of air. The preferred source of B is amorphous B; although other sources of B can be used to form the boron-doped, blue diamond of the present invention.

### CROSS-REFERENCE TO RELATED APPLICATIONS

None

### STATEMENT REGARDING FEDERALLY SPONSORED RESEARCH

Not applicable.

### BACKGROUND OF THE INVENTION

The present invention relates generally to diamond particles and more particularly to increasing their compressive fracture strength and improving their oxidation resistance by substituting boron (B) into the diamond crystal.

Its hardness and thermal properties are but two of he characteristics that make diamond useful in a variety of industrial components. Initially, natural diamond was used in a variety of abrasive applications. With the ability to synthesize diamond by high pressure/high temperature (HP/HT) techniques utilizing a solvent/catalyst aid under conditions where diamond is the thermodynamically stable form of carbon phase, a variety of additional products found favor in the marketplace. Typically, the HP/HT conditions used in the solvent/catalyst synthesizing method includes a temperature in the range of about 1500° to 2000° C. and a pressure in the range of about 5 to 10 GPa. Polycrystalline diamond compacts, often supported on a WC support in cylindrical or annular form, extended the product line for diamond. However, the requirement of high pressure and high temperature has been a limitation in product configuration, for example. Of more recent vintage, is the low-pressure growth of diamond, dubbed “chemical vapor deposition” or “CVD”. Additional product configuration is permitted by this diamond growth technique.

Regardless of whether the diamond is natural or synthetic, and regardless of the manner in which the synthetic diamond has been grown, diamond suffers from being unstable at elevated temperature. As the art is well aware, processing of diamond at temperatures of above 600° to 700° C. requires an inert atmosphere; otherwise, the diamond will oxidize. Thus, the ability to increase the oxidation resistance of diamond would be welcome in the art. For example, the life of diamond tools would be prolonged due to the resistance of diamond to oxidation during tool applications, and in addition, processing of diamond into various tools and workpieces at increased temperatures would be permitted.

Another valuable property of diamond is its compressive fracture strength. Compressive fracture strength measures the mechanical strength of a diamond crystal and is the static force required to break (or fracture) the crystal. Compressive fracture strength is a quantifiable mechanical property of diamond grit. Typically, hundreds of grit are tested and the average force recorded to break the grit is used as the compressive fracture strength of that particular grit product. Heretofore, etching of diamond grit for one hour in molten potassium nitrate at 870° K was reported to increase the strength of the diamond grit due to the removal of surface roughness and defects (See pp. 489-490, The Properties of Natural and Synthetic Diamond, Ed. by J. E. Field, 1992).

Boron doped diamond, which has been proposed in the art (see EP 0 892 092 A1; and U.S. Pat. Nos. 3,148,161; 4,042,673; 4,301,134; and 4,082,185), is considered to have improved oxidation resistance and, perhaps, enhanced mechanical strength. Such boron doped diamond was successfully synthesized using the temperature gradient method. However, the temperature gradient method for producing such boron doped diamond is not an economic method for producing diamond for sawing and grinding purposes, though it may be for gemstone quality diamond. An indication that boron has been incorporated into the lattice of the diamond structure is by its color. Diamond is blue in color with the addition of boron.

Thus, there exists a need in the art to produce boron doped diamond in an economical manner for industrial use in grinding, sawing, and other similar applications.

### BRIEF SUMMARY OF THE INVENTION

A method for producing boron doped diamond for grinding, sawing and other machining applications includes forming a fully dense core (mixture) of graphite, catalyst/solvent sintering aid, optional diamond seed crystals, and a source of boron. This mixture is subjected to diamond-formed high pressure/high temperature (HP/HT) conditions for a time adequate for forming diamond. The thus-formed diamond product is recovered to contain boron substituted into the diamond structure. The fully dense core is substantially devoid of nitrogen (N) content, which mostly comes from air. Thus, the fully dense core is substantially devoid of air. The preferred source of 13 is amorphous B; although other sources of B can be used to form the boron-doped, blue diamond of the present invention.

### BRIEF DESCRIPTION OF THE DRAWINGS

For a fuller understanding of the nature and objects of the present invention, reference should be made to the following detailed description taken in conjunction with the accompanying drawings, in which:

FIG. 1 is the graphical plot of the thermogravimetric analysis results of samples of an untreated diamond; and

FIG. 2 is the graphical plot of the thermogravimetric analysis results of samples of boron doped diamond.

The drawings will be described in detail in the Examples.

### DETAILED DESCRIPTION OF THE INVENTION

Boron is one of only two elements (nitrogen being the other) that can substitute for the carbon atom in the diamond structure. Boron's substitution in diamond structure enables the boron-doped diamond to exhibit improved mechanical strength and oxidation resistance.

As the data will demonstrate, the boron doped diamond crystals of the present invention exhibit improved oxidation resistance. That is, the boron-diffused diamond crystals can tolerate higher temperature than regular industrial diamond. This means that tool manufacturing can process tool making at a higher temperature which can be advantageous to tool manufacturers. Moreover, this also means that the ultimate tools also can be used in tasks that heretofore were foreclosed to diamond because of the expected temperatures that would be encountered in the field. Such advantages should not be limited to any particular tools. That is, the boron-diffused diamond should have advantage in compacts, wire drawing dies, resin bond tools, metal bond tools, saw blades, and the like.

The initial step of the process commences with formation of a uniform mixture of boron and graphite. Diamond seed crystals can be used as is well known in the art. The amount of boron will range from about 0.1 to about 0.5 weight-% of the total core composition with about 0.15 wt-% presently preferred. Sources of boron include, inter alia, B₄C in a range of from about 0.1 to about 0.5 wt-% with 0.25 wt-% being preferred; Fe-B alloy in a range to provide a B content of from about 0.1 to about 0.5 wt-%; metallic boron and amorphous B powder in a range of from about 0.1 to about 0.5 wt-% with about 0.15 wt-% being preferred. The presently preferred source of B is amorphous B having a particle size from about 5 μm to −80 mesh in size. Again, the lower limit is more dictated by handling considerations, especially at commercial scale operations.

In order to excluse N. mostly attributable to air, from being present in the core, the mixture is pressed to be nominally fully dense. Being fully dense, for present purposes, means that the pressed core is substantially devoid of any trapped gasses, notably air as a measure of N content. The presence of N prevents the incorporation of B into the diamond structure, resulting in B being present as an impurity inclusion and consenquently diamond crystals of black color. The novel boron doped, blue diamond has less B as an impurity inclusion than that of black color diamond.

The core, then, is subjected to conventional HP/HT processing in a conventional high pressure/high temperature (HP/HT) apparatuses, which may be of the belt-type or die-type, are described, for example, in U.S. Pat. Nos.; 2,941,241; 2,941,248; 2,947,617; 3,609,818; 3,767,371; 4,289,503; 4,409,193; 4,673,414; 4,810,479; and 4,954,139, and French Pat. No. 2,597,087. Typical temperatures range from about 1500° to about 2000° C. with corresponding pressures ranging from about 5 to about 10 GPa. Times can range from as short as about 30 seconds up to as long as 3 hours or more with times advantageously ranging from around 5 minutes up to 2 hours.

The boron-doped diamond product, then, is recovered from the apparatus in conventional fashion by first lowering the temperature and then the pressure. Conventional finishing operations (e.g., grinding, acid washing, etc.) are used to recover the product, which then can be used in a variety of sawing, grinding, and other industrial applications.

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated. Also, all citations referred herein are expressly incorporated herein by reference.

### EXAMPLE

Thermogravimetric analysis (TGA) is a continuous measurement of sample weight under elevated temperature conditions in a static “air” atmosphere. A decrease in sample weight is indicative of volatile reaction products being evolved from the sample. For diamond, oxygen will react at elevated temperature to form CO, CO₂, and mixtures thereof. J. E. Field (Editor), The Properties of Diamond, Academic Press, New York, N.Y. (1979). TGA curves reported herein were generated on a 951 Thermogravimetric Analyzer by DuPont Instruments with all samples being placed on a platinum sample holder. The temperature was increased at a rate of 10° C/min.

Cores made from graphite and catalyst/solvent metals (sintering aid) with 0.15 wt-% amorphous B were pressed to a fully dense state. The cores then were subjected to conventional HP/HT processing. A recovered fraction,1401170 mesh, having a Toughness Index (TI) of 47 was chosen for testing along with an undoped reference diamond fraction having the same mesh size and a TI of 46.

Thermogravimetric analysis was performed under the following test conditions:

Static air

Samples heated to 850° C. at a rate of 50° C./min

Samples then held at 850° C. for 1 hour

The weight of the samples was monitored and the rate of weight change at 850° C. during the first 8 minutes at temperature was recorded. The presence of air results in oxidation of the diamond.

The following results were recorded:

Rate of weight change of reference diamond: −0.83% per minute

Rate of weight change of B-doped diamond: −0.21% per minute

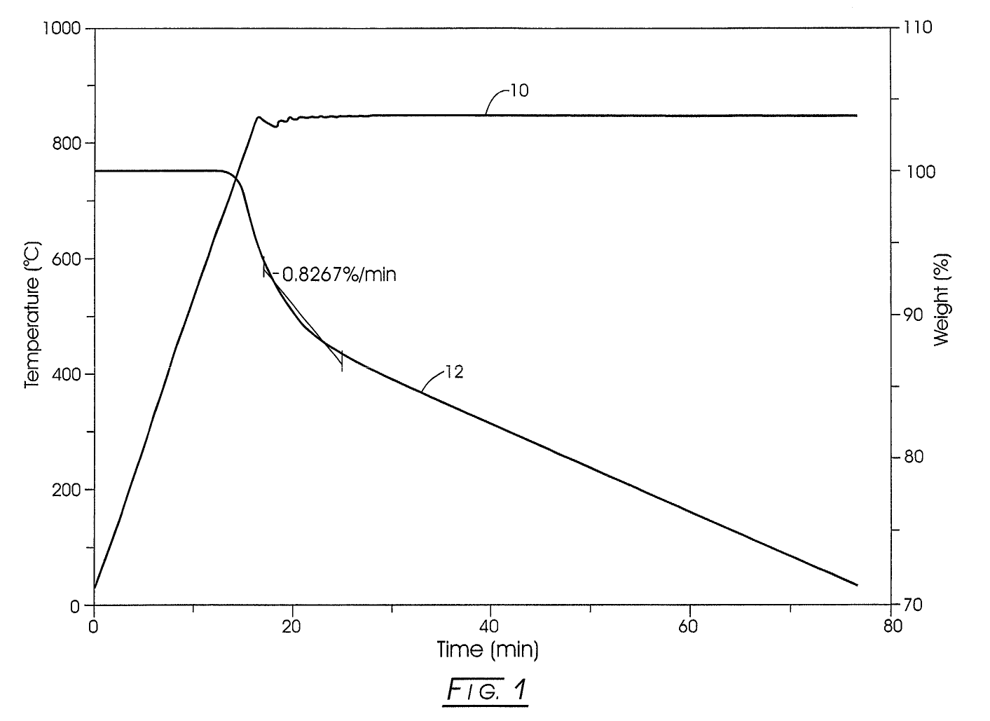

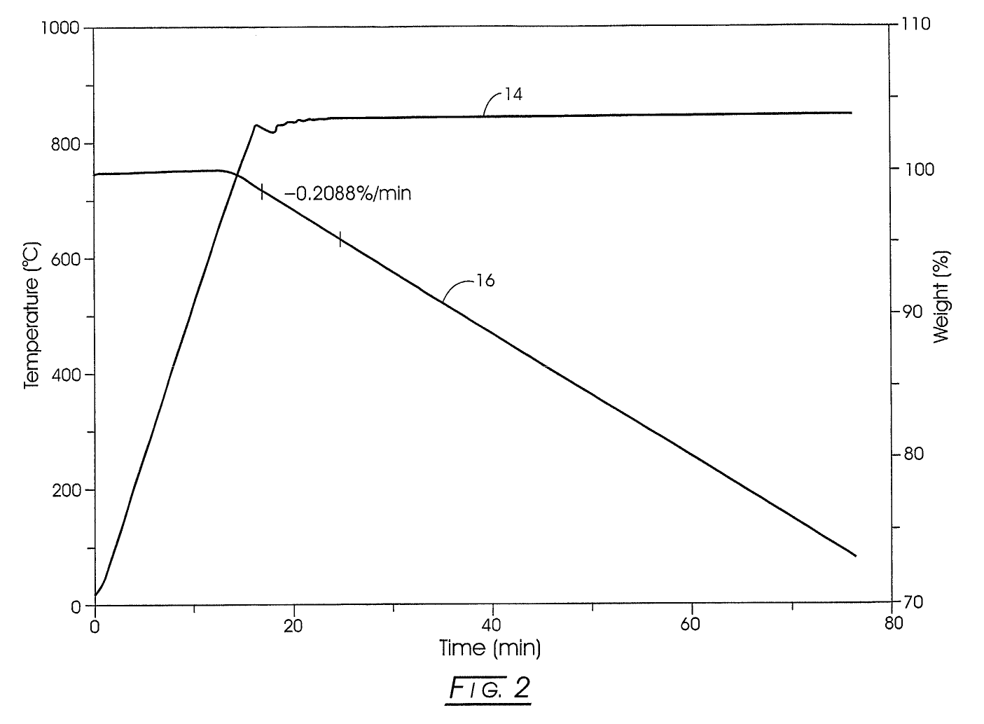

FIG. 1 graphiclly depicts the TGA test results for the comparative sample. Line 10 displays the temperature of heating of the samples, while line 12 represents the amount (wt-%) of the sample. FIG. 2 graphiclly depicts the TGA test results for the inventive, B-doped sample. Line 14 displays the temperature of heating of the samples, while line 16 represents the amount (wt-%) of the sample. These TGA test results reveal the enhanced oxidation resistance that the B diffused samples display versus untreated diamond. The rate of weight loss for the inventive B diffused samples was one-fourth that of the comparative samples.

1. A method for synthesizing boron doped, blue diamond for improving the oxidation resistance, which comprises:
(a) forming a fully dense core of graphite, catalyst/solvent metals, optional diamond seed crystals, and a source of boron;
(b) subjected said fully dense core to diamond forming high pressure/high temperature (HP/HT) conditions for a time adequate for forming diamond having boron substituted into the diamond structure; and
(c) recovering said boron diamond product.

2. The method of claim 1, wherein the amount of boron in said core ranges from about 0.1 to about 0.5 weight-% of the total core.

3. The method of claim 2, wherein said boron is B₄C.

4. The method of claim 3, wherein the amount of said B₄C ranges of from about 0.1 to about 0.5 wt-%.

5. The method of claim 2, wherein said boron is an FeB alloy.

6. The method of claim 5, wherein the B content of said alloy ranges from from about 0.1 to about 0.5 wt-%.

7. The method of claim 2, wherein said boron is metallic boron.

8. The method of claim 7, wherein said metallic boron is present in an amount of about 0.1 to 0.5 wt-%.

9. The method of claim 2, wherein said boron is amorphous B powder.

10. The method of claim 9, wherein said amorphous B powder ranges of from about 0.1 to about 0.5 wt-%.

11. The method of claim 10, wherein said amorphous boron powder ranges in size from between about 5 μm to about 45/50 mesh.

12. The method of claim 1, wherein said HP/HT conditions include a temperature ranging from about 1500° to about 2000° C. with corresponding pressures ranging from about 5 to about 10 Gpa.

13. The boron doped diamond made by the process of claim 1.

14. The boron doped diamond made by the process of claim 2.

15. The boron doped diamond made by the process of claim 3.

16. The boron doped diamond made by the process of claim 5.

17. The boron doped diamond made by the process of claim 7.

18. The boron doped diamond made by the process of claim 9.

19. The boron doped diamond made by the process of claim 10.

20. The boron doped diamond made by the process of claim 12.
